(19) United States
(12) Patent Application Publication
(10) Pub. No.: US 2018/0182179 A1
(43) Pub. Date: Jun. 28, 2018

(54) COMPREHENSIVE SYSTEM AND METHOD FOR REAL-TIME MONITORING AND MANAGEMENT OF SECURITY PATROLLING OPERATIONS

(71) Applicant: Infostandard Sdn. Bhd., Kuala Lumpur (MY)

(72) Inventors: Hon Seng Teh, Kuala Lumpur (MY); Kok Loong Pang, Kuala Lumpur (MY)

(73) Assignee: Infostandard Sdn. Bhd., Kuala Lumpur (MY)

(21) Appl. No.: 15/840,181

(22) Filed: Dec. 13, 2017

(30) Foreign Application Priority Data
Dec. 22, 2016 (MY) PI 2016704768

(51) Int. Cl. G07C 1/20; G06Q 50/26; G01C 21/20; H04W 4/33

(52) U.S. Cl. CPC G07C 1/20; H04W 4/33; G01C 21/206; G06Q 50/265

(57) ABSTRACT

The present disclosure relates to a comprehensive system and associated method for real-time monitoring and management of the patrolling operations by a number of security personnel. The present system includes one or more electronic communication devices that are configured to run a security patrol management application. The system further includes a centralized server running a server side security patrol management application capable of directly communicating with the security patrol management application running on the electronic communication devices. The server side security patrol management application includes a number of features that allows the administrators or managers for monitoring and managing the operations of the security personnel through an interactive visual interface of the application. The server side security patrol management application is a cloud-based application to collect a variety of information to monitor and manage the patrolling operations of the security personnel in real-time.

### CROSS-REFERENCE TO RELATED APPLICATION

The instant application claims priority to Malaysia Patent Application Ser. No. PI 2016704768 filed Dec. 22, 2016, the entire specification of which is expressly incorporated herein by reference.

### FIELD OF THE INVENTION

The present invention generally relates to security systems for managing security personnel. More particularly, the present invention relates to a system and method for real-time monitoring and management of patrolling operations by security personnel.

### BACKGROUND OF THE INVENTION

Security guards and security systems are as important now in the modern age as they have been historically, but many of the systems used by security teams seem archaic compared to many of the technological marvels they guard. Security guards today often rely on walkie-talkies or phones to communicate with each other. When an incident occurs they often fill out a paper form to put in a filing system. They may use punch cards, sign in boards to sign in or clocking devices on patrol routes. With the social development and scientific and technological progress, the industry demand for security services is growing. This also requires security services more standardized and scientific. Patrol service is one of the main businesses of security services, which is mainly set for a particular area. The patrol services have to ensure the protection of location, objects and persons and also involve target security management and execution inspection checks and alert services. For efficient management of the patrolling operations, traditional patrol system requires more security personnel for and managers or monitoring personnel for ensuring that the patrolling operations is performed in accordance with preset patrol routes, with patrol checkpoints or reading points, and at the end of the patrol the managers or monitoring personnel has to manually verify all these details and has to upload the details to a computer. The traditional patrol system up to some extent assists in the operation of security personnel, but there are still many drawbacks. Using the traditional way, the security personnel must follow predefined patrol routes, the system must be wired and embedded in the patrol routes, involves high complexity of construction and execution. Moreover the supervising officer cannot immediately understand the patrolling operation and status of the patrolling guards, including whether patrolling is required by security personnel at a particular area or not etc. Moreover the traditional methods cannot guarantee that the security personnel patrolling the patrolling area performs the required tasks or not and would not allow the supervising officer to monitor real-time situation and incidents occur during the patrolling operation. In particular, if faced with an emergency, the security personnel may not be able to properly handle the situation. Further, using the existing systems, the safety of security personnel is also difficult to monitor and protect during the patrolling process.

There are also some electronic patrol management systems, such as Chinese patent publication CN 101470907 A, which discloses a technical solution for managing the patrolling operation. The system includes an IC tag reader or a built-in IC tag and mobile phones to read the settings in the inspector IC tag location or dispatch location or at the checkpoints during patrolling. The system collects the location data and the read position information using the phone's positioning function and transfers the data to a remote server. The system displays an interactive map of the location and allows the supervisors to monitor whether the patrolling guards perform correct tour or not. However above systems rely on single PC software to capture patrolling records. There is no multi levels access for multi system users, neither to concurrently login to the system nor to review the data. Moreover the above system does not provide a comprehensive means for real-time monitoring and management of patrolling operations by security personnel.

Another application WO 2006096431 A2 discloses methods and devices for locating emergency service providers during emergency operations. The system includes radio frequency identification (‘RFID’) tags positioned at various locations throughout a building. Building locations can be determined from the RFID tags. Emergency service providers may be equipped with a portable device that includes at least one RFID reader for reading the RFID tags. Some implementations of the system involve transmitting the RFID tag data to a control center from which the emergency services are coordinated. The emergency service workers' current and prior locations can be determined by the portable devices and/or at the control center. However the above system is more concentrated on managing emergency service personnel. Moreover the above systems rely on single PC software to manage the emergency service personnel. There is no multi levels access for multi system users, neither to concurrently login to the system nor to review the data. Moreover the above system does not provide a comprehensive means for real-time monitoring and management of patrolling operations by security personnel.

Hence there exists a need for an improved comprehensive system for system for real-time monitoring and management of patrolling operations by security personnel.

### SUMMARY OF THE INVENTION

The present invention relates to a comprehensive system and associated method for real-time monitoring and management of the patrolling operations by a number of security personnel. Security personal management companies or security service providers can utilize the present system for real-time monitoring and managing of a variety of operations including the patrolling operation of the security personnel. The present system includes one or more electronic communication devices that are configured to run a security patrol management application. The electronic communication devices are used by the security personnel and the administrators or managers for monitoring and managing the operations of the security personnel. The system further includes a centralized server running a server side security patrol management application capable of directly communicating with the security patrol management application running on the plurality of electronic communication devices. The server side security patrol management application includes a number of features that allows the administrators or managers for monitoring and managing the operations of the security personnel through an interactive visual interface of the application. The server side security patrol management application is a cloud-based application to collect a variety of information to monitor and manage the patrolling operations of the security personnel in real-time. The server side security patrol management application collects and processes information including real-time location information of the security personnel, information from a plurality of patrol checkpoints determined by the administrators or managers, a variety of other data including alerts, text, audio, video and other type of information and a plurality of other information including performance parameters of the security personnel from the electronic communication devices of the security personnel. The above information is collected using the security patrol management application running on the electronic communication devices of the security personnel and are transferred to the server side security patrol management application running on the server through a communication channel, which enable secure, reliable and real-time communication between the electronic communication devices and the centralized server. The security patrol management application running on the electronic communication devices allows the security personnel to receive a variety of data and instructions from the server side security patrol management application running on the centralized server. Moreover the security patrol management application running on the electronic communication devices enables automated transmission of the variety of information to the centralized server for real-time monitoring and management of the operations of the security personnel.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a block diagram of the present comprehensive system for real-time monitoring and management of the patrolling operations by a number of security personnel, according to a preferred embodiment of the present invention;

FIG. 2 illustrates a block diagram showing the main components of the electronic communication device, according to the preferred embodiment of the present invention;

FIG. 3 illustrates a block diagram showing the main components of the centralized server, according to a preferred embodiment of the present invention;

FIG. 4 illustrates a block diagram showing the different modules associated with the present security patrol management application, according to a preferred embodiment of the present invention; and

FIG. 5 illustrates a flowchart showing a method for real-time monitoring and management of patrolling operations by the security personnel, according to a preferred embodiment of the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, software, hardware and other changes may be made without departing from the scope of the embodiments. The following detailed description is therefore not to be taken in a limiting sense. Any reference to claim elements in the singular, for example, using the articles “a,” “an” or “the,” is not to be construed as limiting the element to the singular.

The present disclosure relates to a computer assisted comprehensive system for effectively managing a variety of operations of the security personal management companies or security service providers and a number of security personnel associated with the security personal management companies or the security service providers. The present system is implemented using a number of electronic communication devices, one or more servers and a security patrol management application configured to run on these devices. Further the present system may also include a number of sensors or NFC tags or other tracking devices or other electronic devices capable of communicating with the electronic communication devices or the servers, according to one or more embodiments of the present disclosure. The present system relies on cloud-based technologies to provide an uninterrupted service for effectively managing the operations of the security personal management companies or security service providers and the activities of their security personnel. The present system offers real-time monitoring and management of the security personnel during patrolling operations. In addition, the present system enables the administrators or managers of the personal management companies or security service providers to pre-plan the tasks and patrolling routes of the security personnel through an interactive user interface of the security patrol management application. The present system enables the administrators or managers of the security personal management companies or security service providers and the security personnel to easily perform their duties by fully or partially automating a variety of tasks including monitoring and management of the patrolling operation through the user interface of the security patrol management application.

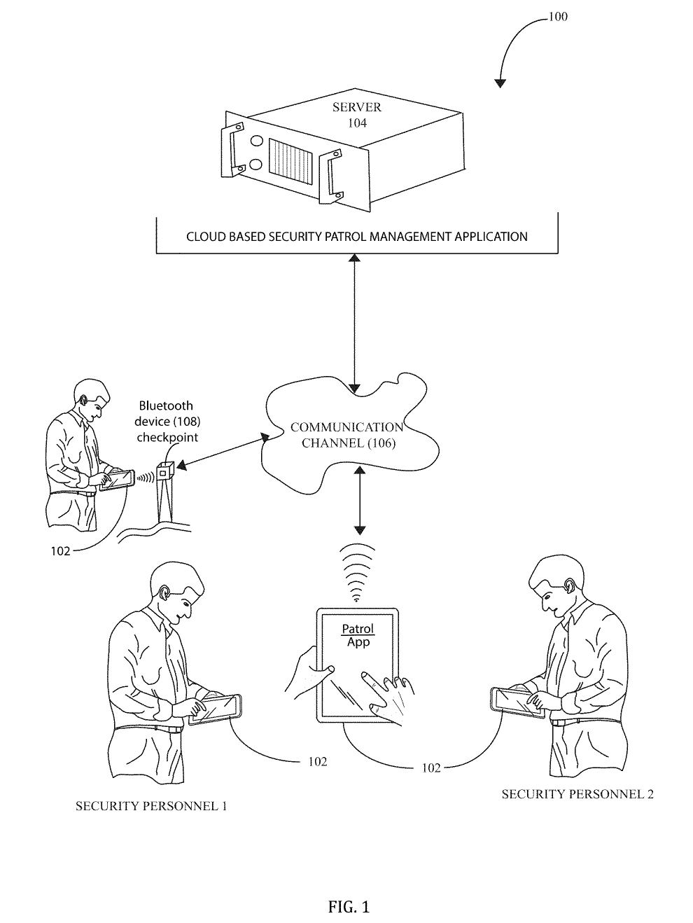

FIG. 1 illustrates a block diagram of the present comprehensive system (100) for real-time monitoring and management of the patrolling operations by a number of security personnel, according to a preferred embodiment of the present invention. Security personal management companies or security service providers can utilize the present system (100) for real-time monitoring and managing of a variety of operations including the patrolling operation of the security personnel. The present system (100) includes one or more electronic communication devices (102) that are configured to run a security patrol management application. The electronic communication devices (102) are used by the security personnel and the administrators or managers for monitoring and managing the operations of the security personnel. The system (100) further includes a centralized server (104) running a server side security patrol management application capable of directly communicating with the security patrol management application running on the plurality of electronic communication devices (102). The server side security patrol management application includes a number of features that allows the administrators or managers for monitoring and managing the operations of the security personnel through an interactive visual interface of the application. In a preferred embodiment, the server side security patrol management application is a cloud-based application to collect a variety of information to monitor and manage the patrolling operations of the security personnel in real-time. The server side security patrol management application collects and processes information including real-time location information of the security personnel, information from a plurality of patrol checkpoints determined by the administrators or managers, a variety of other data including alerts, text, audio, video and other type of information and a plurality of other information including performance parameters of the security personnel from the electronic communication devices (102) of the security personnel. The present system (100) includes a wireless communication device (108) provided at the plurality of checkpoints to communicate with the electronic communication devices (102) of the security personnel. The security personnel can check-in into the plurality of checkpoints by enabling interaction with the electronic communication device (102) and a wireless communication device (108). The wireless communication device (108) includes a Bluetooth beacon assigned with a unique ID by the security patrol management application running on the server (104). The electronic communication device (102) is provided with a wireless chip including Bluetooth and/or NFC chip to allow the security personnel to check-in at the plurality of checkpoints. The check-in and patrolling details of the security personnel are sent to the centralized server (104) over the communication channel (106) in real-time. The above information is collected using the security patrol management application running on the electronic communication devices (102) of the security personnel and are transferred to the server side security patrol management application running on the server (104) through a communication channel (106), which enable secure, reliable and real-time communication between the electronic communication devices (102) and the centralized server (104). The security patrol management application running on the electronic communication devices (102) allows the security personnel to receive a variety of data and instructions from the server side security patrol management application running on the centralized server (104). Moreover the security patrol management application running on the electronic communication devices (102) enables automated transmission of the variety of information to the centralized server (104) for real-time monitoring and management of the operations of the security personnel.

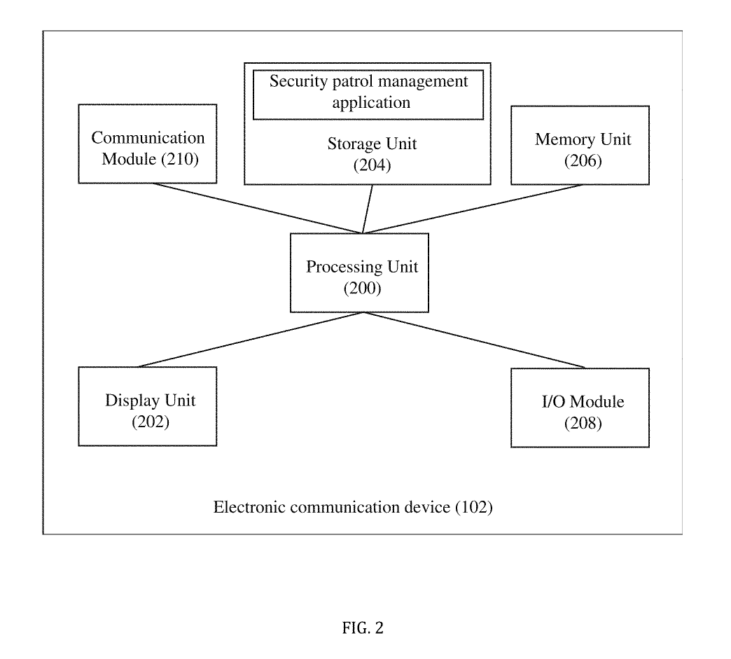

FIG. 2 illustrates a block diagram showing the main components of the electronic communication device (102). The present electronic communication device (102) is a portable electronic communication device configured to run the security patrol management application and capable of communicating with the server side security patrol management application running on the centralized server (104) through the communication channel (106). The electronic communication device (102) includes, but not limited to, a smartphone, tablet, a portable computer, a smart wearable device such as a smart watch or any other smart portable device that can be carried by the security personnel during patrolling operation. The present electronic communication device (102) can be used to automatically collect and send information to the server side security patrol management application running on the centralized server (104) through the communication channel (106). The present electronic communication device (102) further enables security personnel to receive a variety of information including alerts from the administrators or managers through the server side security patrol management application running on the centralized server (104). In addition, the security personnel can interact with the digital contents presented through the user interface of the security patrol management application launched from the electronic communication device (102). The present electronic communication device (102) includes a processor (200) and associated electronic components for processing the information received using the device and the information received from the centralized server (104), a display unit (202) for displaying a graphical user interface of the security patrol management application, a storage unit (204) to store the information received using the device and the information received from the centralized server (104), a memory unit (206) for temporary storage of data during execution of a plurality of instructions by the processor (200), a plurality of input/output ports (208), such as, but not limited to, Universal Serial Bus (USB) ports, headphone jacks, and other ports to operably connect a plurality of external electronic devices and a communication module (210) to enable wireless communication with other devices and the server (104) over the wireless communication channel (106) such as, but not limited to, Wi-Fi, mobile data communication etc. The storage unit (204) stores the security management application and associated files and the information collected by the security personnel during the patrolling operation, which includes text, audio, video and other type of information collected using the electronic communication device (102). In some embodiment, the display unit (202) is a touch screen display allowing the security personnel to interact with the graphical user interface of the security patrol management application using gestures or touch. The security personnel can visualize a variety of information such as maps of locations, buildings, patrolling zones, checkpoints and other patrolling related information and one or more alerts and reminders from the administrators or managers managing them through the security management application.

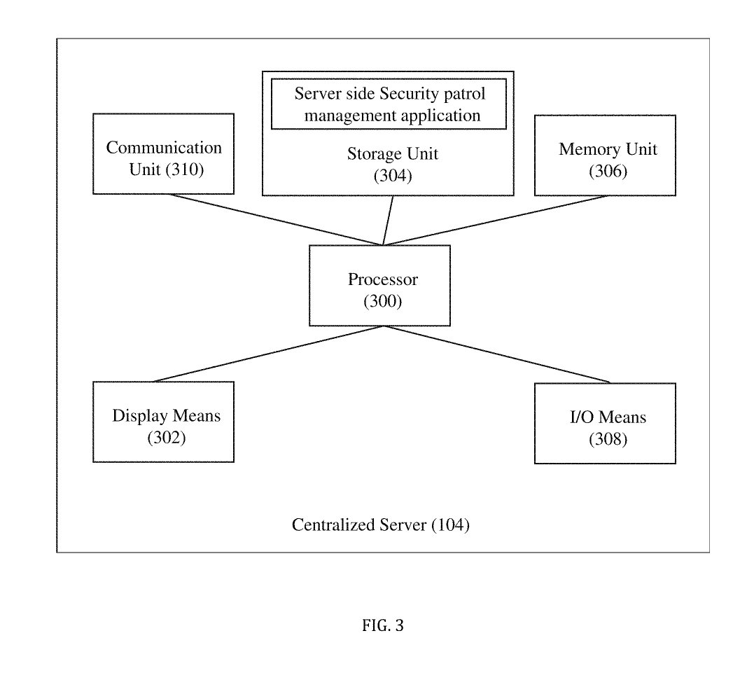

FIG. 3 illustrates a block diagram showing the main components of the centralized server (104), according to a preferred embodiment of the present invention. The centralized server (104) has similar components as that of a computer system and is configured to run the server side security management application of the present system (100). In a preferred embodiment, the centralized server (104) is provided as a cloud based server offering the security personnel monitoring and management services through the Internet. In the case of cloud based service, there may be multiple centralized servers (104) in the system (100), which are in sync with each other and communicates with the electronic communication devices (102) of the security personnel over the communication channel (106). This ensures uninterrupted service to the security personnel and the administrators or managers managing them. In case of the cloud based service, the security patrol management application is accessible from the electronic communication devices (102) of the security personnel over the communication channel (106) such as the Internet. The security personnel can launch a web application or website associated with the security patrol management application from the web browser or application on the electronic communication devices (102) and can view the information presented through its user interface. In any case, the centralized server (104) includes the following major components such as, a processor (300) and associated electronic components for processing the information received from the electronic communication device (102), a display unit (302) for displaying a graphical user interface of the server side security patrol management application, a storage unit (304) to store the information received from the electronic communication devices (102), a memory unit (306) for temporary storage of data during execution of a plurality of instructions by the processor (300), a plurality of input/output ports (308), such as, but not limited to, Universal Serial Bus (USB) ports, headphone jacks, and other ports to operably connect a plurality of external electronic devices and a communication module (310) to enable wireless communication with other devices (102) and other servers (104) over the wireless communication channel (106) such as, but not limited to, Wi-Fi, mobile data communication etc. The storage unit (304) stores the server side security management application and associated files and the information received from the security personnel during the patrolling operation, which includes text, audio, video and other type of information collected using the security management application running on the electronic communication device (102). In some embodiment, the display unit (302) is a touch screen display allowing the administrators or managers to interact with the graphical user interface of the server side security patrol management application using gestures or touch. The administrators or managers can visualize a variety of information such as maps of locations, buildings, patrolling zones, checkpoints, real-time location and activity related information of the security personnel and other patrolling related information and one or more emergency alerts and SOS received from the security personnel during patrolling operation.

In certain embodiment of the present invention the security patrol management application configured to run on the electronic communication devices (102) and the server side security patrol management application configured to run on the centralized server (104) are the same application. However, one or more features presented to the registered administrators and managers of the security personnel are different from the features presented to the authorized security personnel. For example, the security personnel may not be able to access the activity monitoring and activity scheduling sections of the security patrol management application. Such an application can be made available to the security personnel and the administrators and managers of the security personal management companies or security service providers through a cloud platform. The registered security personnel and the administrators and managers can login to the security patrol management application launched from the electronic communication devices (102) through a web browser or web application or an application. The security personnel can access the duty or patrolling briefings, location map and other information from the user interface of the security patrol management application and the administrators and managers can access the above said information in addition to the monitoring, activity scheduling and other specific monitoring and management sections of the security patrol management application.

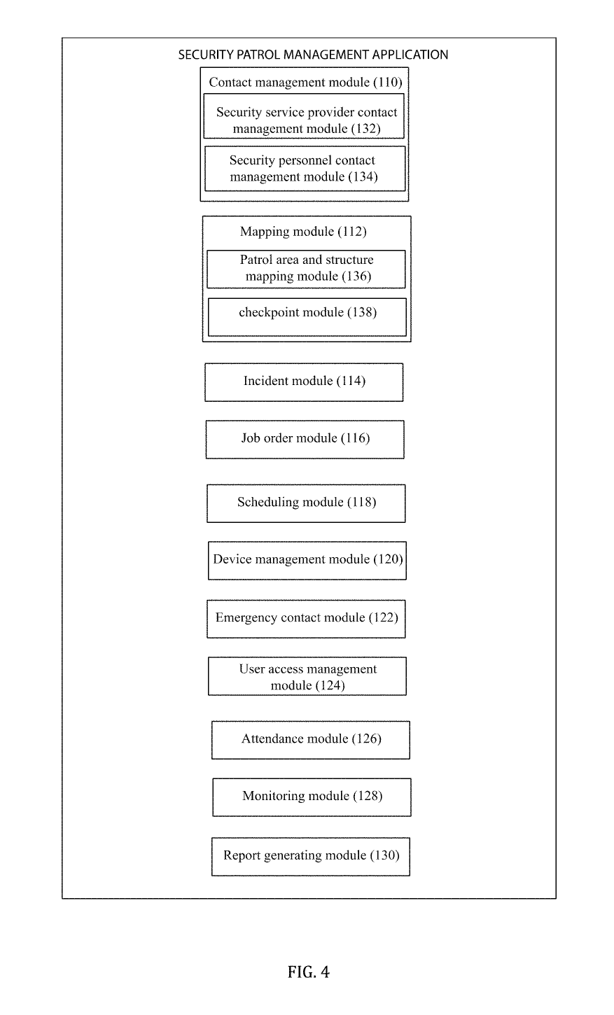

FIG. 4 illustrates a block diagram showing the different modules associated with the present security patrol management application, according to a preferred embodiment of the present invention. The security patrol management application includes a contact management module (110) for managing plurality contact information of the plurality of security personnel and a plurality of security service providers. The contact management module (110) includes a security service provider contact management module (132) and a security personnel contact management module (134). The security service provider contact management module (132) stores a plurality of information related to the security service provider including the registration information, official address, location of offices, number of employees including the number of security personnel managed by the security service provider, and other company related information. The security service providers can install the application in their computers or other portable devices such as a smartphone and can register into the application after providing the requested information. In some instances, the security patrol management application is available as a cloud based application, and the security service providers can access the application in their computers or other portable devices such as a smartphone through web browsers or other web based application and can register into the application after providing the requested information. The security service provider contact management module (132) provides a unique company ID for each of the security service provider. The security personnel contact management module (134) manages information related to the security personnel, which includes the name, address, official id, and other personal and professional information of the security personnel. The security personnel can install the security patrol management application in their electronic communication devices (102) such as smartphone and launch the application to register. In some instances, the security patrol management application is available as a cloud based application, and the security personnel can access the application using their smartphone or other portable through web browsers or other web based application and can register into the application after providing the requested information. The security service providers can login to their accounts and add the details of their employees including the security personnel. In addition, the security personnel contact management module (134) allows the security personal to register and login to the security patrol management application. Once the security personnel register into the application for working under a particular security service provider, he will be provided with a unique guard ID under the unique company ID. Further the security personnel can receive notifications and other information through the user interface of the security patrol management application. The security patrol management application saves all the information and sends the information to the server side security patrol management application running on the centralized server (104) for secure storage in a database associated with the application.

The security patrol management application also includes a mapping module (112) to define a plurality of structures, a plurality of objects and a plurality of checkpoints in a patrolling area. The mapping module (112) provides an interactive map of the plurality of structures, objects and the checkpoints in the patrolling area. The mapping module (112) includes a patrol area and structure mapping module (136) to map and visually present the structures and objects including buildings, floors and zones in the patrolling area and a checkpoint module (138) to setup and visually present the checkpoints and a plurality of patrolling rules through the interactive map. The patrol area and structure mapping module (136) define buildings, floors, zones, in a surveillance area and provides a tree view or interactive view of them through the graphical user interface of the security patrol management application running on the electronic communication device (102). The checkpoint module (138) is used to set up checkpoints and patrolling routes of the security personnel. The checkpoint module (138) also forms an integral part of the server side security patrol management application to define checkpoints such as building, floors, zones, etc. Each of the checkpoints will be assigned with a unique checkpoint ID for easy reference. The checkpoint module (138) also defines the type of data to be captured at the checkpoints and to be sent to the centralized server (104). The data may include, photo, video or any other information such as scanning or entry/exit information into a building or a floor. The checkpoint module (138) further allows the administrators or the mangers of the registered security service provider companies to define the scan options at the particular checkpoint and duration to be spent by the security personnel at the checkpoint. Further the checkpoint module (138) also allows the security personnel to automatically associate an incident with a particular checkpoint using the checkpoint ID. This enables the easy tracking and reporting to emergency services in case of any mishaps at a particular checkpoint.

The security patrol management application further includes an incident module (114) to define and report a plurality of incidents during patrolling operation of the security personnel. The incident module (114) allows the administrators or the mangers of the registered security service provider companies to define the types of incidents that might happen during the patrolling operation of the security personnel. The types of incidents are saved in the database and are presented through the user interface of the security patrol management application. The security personnel can select the desired type of incident for reporting of such an incident during the patrolling operation. Further the incident module (114) allows the security personnel to capture and send a photo or video of the incident using his/her electronic communication device (102), such as smartphone, during the patrolling operation. The checkpoint module (138) communicates with the incident module (114) during reporting of the incident at the checkpoints or zones or building belonging to the particular checkpoint. This enables pinpoint tracking of the location of the incident and allows the administrators or the mangers to handle the incident in a systematic manner, which includes sending back up security personnel to the checkpoint or sending alerts to the law enforcement personnel with the available information including the photo and/or video and the location information. The centralized server (104) receives the photo or video of the incident and stores it as evidence or proof of the incident. This stored information can be made available to law enforcement personnel for investigation or as a proof of the incident.

The security patrol management application then includes a job order module (116) to define and assign a plurality of jobs to the security personnel during patrolling operation. The job order module (116) enables the administrators or the mangers of the security personal management companies to define or allocate or assign additional jobs to the security personal during their patrolling operation. The job order module (116) allows the administrators or the mangers of the security personal management companies to assign a number of extra or additional jobs, which are in addition to the usual patrolling operation, to the security personnel and prioritize the jobs based on a job order list created using the security patrol management application. The jobs are assigned to the security personnel, during their patrolling, as alerts or notifications through the security patrol management application running on the electronic communication device (102) of the security personnel. The security personnel can view the jobs and accept the assigned jobs and can proceed with the patrolling operation as directed by the security patrol management application. The security personal can completes the assigned jobs through the security patrol management application alone or as pairs at the checkpoints, as directed by the administrators or the mangers of the security personal management companies through the security patrol management application. The checkpoint module (138) communicates with the job order module (116) to enable the administrators or the mangers to easily manage the jobs assigned to the security personnel through the security patrol management application.

The security patrol management application further includes a scheduling module (118) to schedule and route the plurality of security personal for patrolling operation. The scheduling module (118) allows the administrators or the mangers of the security personal management companies to define patrol schedules and routes for each of the security personnel. The scheduling module (118) allows the administrators or the mangers to schedule the timing of patrol for each of the service personnel and the rules for obtaining valid attendance for them during the patrolling operation at the selected checkpoints during patrolling. The scheduling module (118) works with the checkpoint module (138) and the job order module (116) to assign extra jobs to the service personnel during their patrolling operation. The administrators or the mangers can utilize the scheduling module (118) of the security patrol management application communicates with the checkpoint module (138) to pair the selected checkpoints IDs with the schedule to build the patrolling routes. Each of the scheduled routes are given route IDs using the scheduling module (118) for easy reference and tracking using the security patrol management application.

The security patrol management application includes a device management module (120) to automatically configure the electronic communication devices (102), such as smartphones of the security personnel for use during the patrolling operation. The electronic communication devices (102) such as smartphone, tablets or wearable devices assigned to the security personnel can be set up with the help of the administrators or the mangers of the security personal management companies. Each of the electronic communication devices (102) assigned to or registered to the security personnel are given a unique device ID. The present system (100) can easily recognize and manage the electronic communication devices (102) assigned to or registered to the security personnel using the device IDs. In a preferred embodiment of the present system (100), the electronic communication devices (102), such as smartphones, assigned to or registered to the security personnel are installed with the security patrol management application. The security personnel can launch the application during their patrolling to receive instructions and alerts from the centralized server (104) and to transfer information collected during the patrolling operation to the server (104).

The security patrol management application includes an emergency contact module (122) to set at least one emergency contact for contacting in the event of an emergency. The administrators or managers of the security personal management companies can set emergency contact numbers for each of the security personal through the security patrol management application. In case of an emergency during the patrolling operation, the security personnel can directly access the emergency contact from the user interface of the security patrol management application. The emergency contact may include contact information of law enforcement personnel and other security personnel in proximity. In some instance, the security personnel can launch the security patrol management application from their electronic communication device (102) such as smartphone and manually set the emergency contacts for contact in case of an emergency. The user interface of the security patrol management application may include emergency contact buttons that allows the security personnel to directly communicate with the emergency contacts in case of emergency during the patrolling operation.

Further the security patrol management application includes a user access management module (124) to configure at least one access level of each of the user including the plurality of security personnel and the administrators of the security personal management companies. The user access management module (124) manages the user rights and sets the access level for each type of user such as the security personnel and the administrators of the security personal management companies. Each user can be assigned with different set of access rights for accessing one or more features of the security patrol management application. For example the administrators or managers are provided with some access rights, which are different from the access rights of the security personnel. These access rights include the provision for managing the security personnel, monitoring the operations of the security personnel, etc., which are made not available to the access rights of the security personnel. The different access rights provide different user interfaces at one or more places of the security patrol management application of the security personnel and the administrators or managers of the security personal management companies. The security personnel and the administrators or managers logging into the security patrol management application using their unique user credentials may visualize slightly different user interfaces with different types of options.

The security patrol management application further includes an attendance module (126) to capture a plurality of attendance and job timings of the security personnel. The electronic communication device (102) of the security personnel includes real-time location tracking modules or chips such as GPS chips and other communication chips such as NFC chips to communicate with selected checkpoints and to provide real-time location information of each of the security personnel. Further the attendance module (126) captures and publishes the patrolling records of all the security personnel, list of incidents reported through the security patrol management application and the details of the reporting including time, location, etc., evidence captured using the security patrol management application including photo, video, etc. and the latest status of each of the incident. The authorized personnel including the administrators or the managers and the authorized security personnel can view the published information through the user interface of the security patrol management application.

The security patrol management application further includes a monitoring module (128) to capture a plurality of real-time information including real-time location information of the security personnel, information from the plurality of patrol checkpoints including real-time scanning information, other data including alerts, text, audio and video information from the electronic communication devices (102) etc. The information collected using the security patrol management application running on the electronic communication devices (102) of the security personnel is sent to the centralized server (104) for storage and further analysis. The collected records or information are presented in a line-by-line format on the user interface of the security patrol management application. The records includes the checkpoint information, date and time reported by security personnel, evidence such as video and image collected by the security personnel using the electronic communication devices (102), etc., which are presented to the authorized users of the security patrol management application. This real-time monitoring module (128) of the security patrol management application allows the efficient and systematic operation of the present system (100). The security patrol management application further includes a report generating module (130) to generate a plurality of reports including a plurality of patrolling operation related reports of each of the security personnel. The security patrol management application allows the authorized personnel including the administrators or the managers to view the reports, select types of reports, apply filters, apply date range to view the reports in a specific period and can be opted for displaying or downloading the selected reports in a digital format.

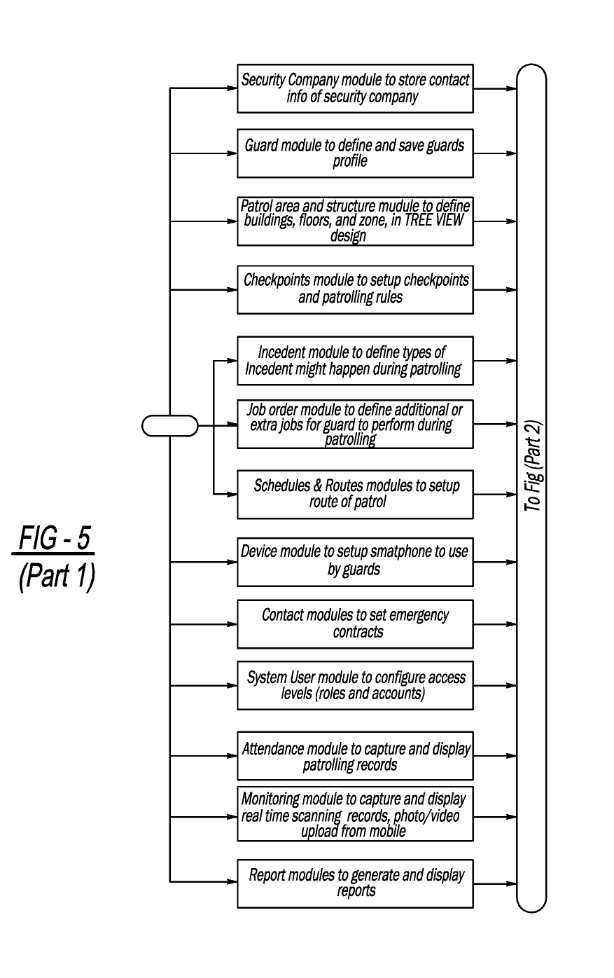

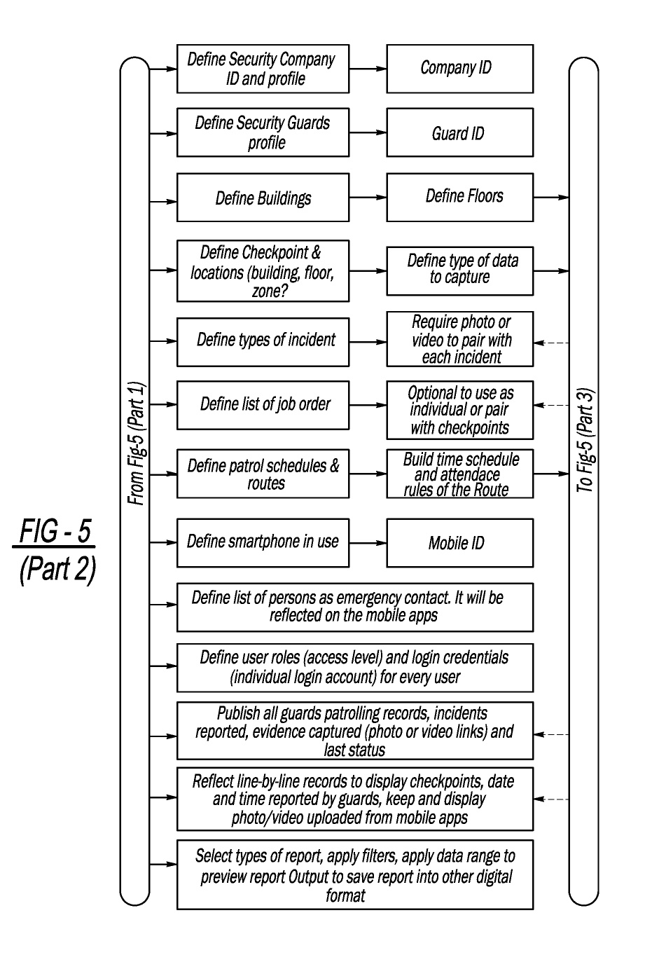

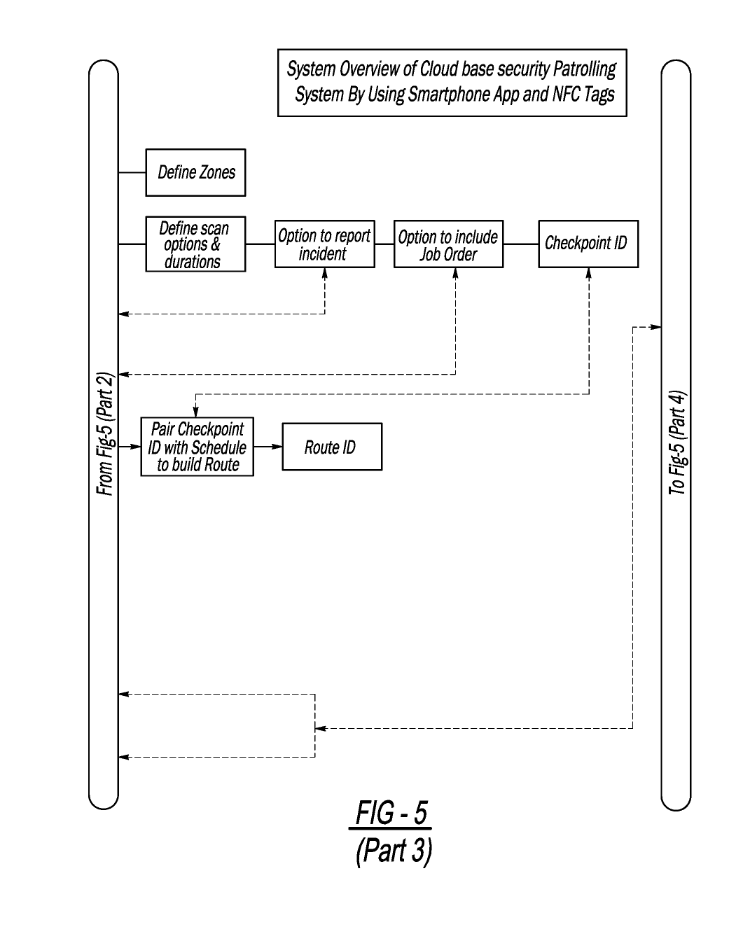

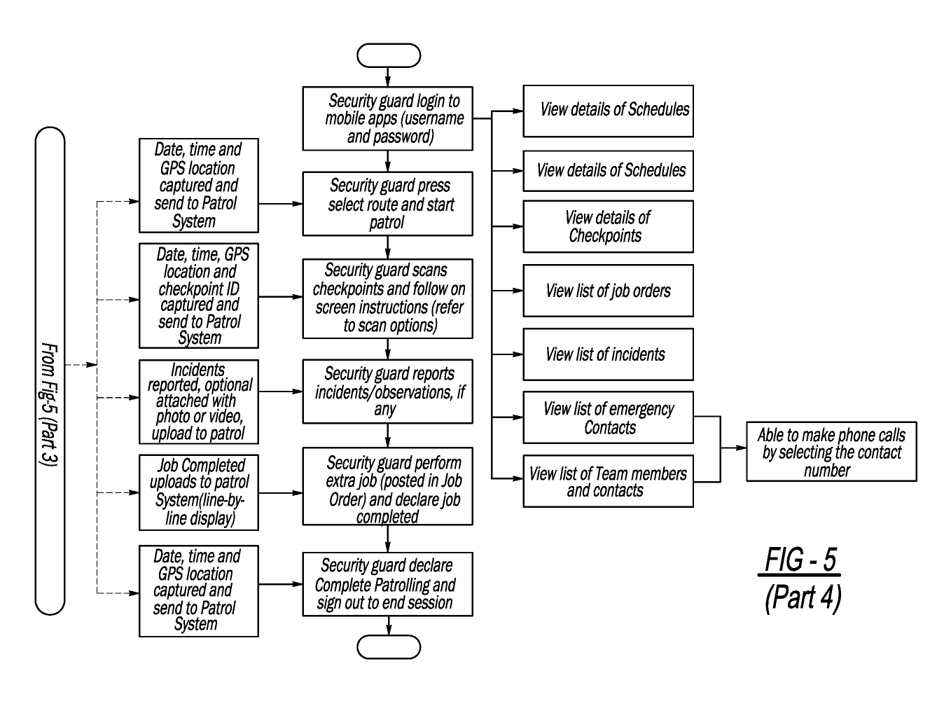

FIG. 5 illustrates a flowchart showing a method for real-time monitoring and management of patrolling operations by the security personnel, according to a preferred embodiment of the present invention. The method for real-time monitoring and management of the patrolling operations by the security personnel includes the steps of providing an electronic communication device (102) configured to run a security patrol management application. The electronic communication devices (102) includes a smartphone, table, smart wearable device and any other smart device capable of launching the security patrol management application for communicating with the centralized server (104). The security patrol management application includes a mobile application, web application and cloud application accessible from the electronic communication devices (102). The centralized server (104) is a cloud based server running the server side security patrol management application capable of being accessed from the plurality of electronic devices through at least one web browser and at least one web application. A communication channel (106) such as a wireless communication channel including Wi-Fi, mobile data or any other wireless communication means enable communication between the electronic communication devices (102) and the centralized server (104). The method further includes the steps of allowing the plurality of security personnel to register into the security patrol management application. The security personnel are provided with at least one unique user credentials for logging into the security patrol management application. The registered security personnel can view the patrolling schedules, details of the checkpoints in the patrolling route present in the schedule, view the list of job orders from the security service provider company, view the types of incidents reported during the patrolling operation and the details of the incidents such as the location, time, and any other evidence of the incident such as video or image, view a list of emergency contacts and contacts of team members for communication during an emergency situation, etc. through the user interface of the security patrol management application. The security personnel can call the emergency contacts and the team members listed in the emergency contact list, in case of emergency, using the electronic communication devices (102) such as the smartphone.

The method follows the steps of providing a plurality of patrol schedules for the plurality of security personnel through the user interface of the security patrol management application. The patrolling schedules presented to the security personnel include the details such as date, time, GPS location map, checkpoint details etc. The security personnel are then allowed to select at least one patrol route involving a plurality of checkpoints for performing the patrolling operation and can follow the onscreen instructions on the electronic communication devices (102) to perform the patrolling operation. The security personnel are then allowed to check-in to the plurality of checkpoints using the electronic communication device (102). The present system (100) includes a wireless communication device (108) provided at the plurality of checkpoints to communicate with the electronic communication devices (102) of the security personnel. The security personnel can check-in into the plurality of checkpoints by enabling interaction with the electronic communication device (102) and a wireless communication device (108). The wireless communication device (108) includes a Bluetooth beacon assigned with a unique ID by the security patrol management application running on the server (104). The electronic communication device (102) is provided with a wireless chip including Bluetooth and/or NFC chip to allow the security personnel to check-in at the plurality of checkpoints. The check-in and patrolling details of the security personnel are sent to the centralized server (104) over the communication channel (106) in real-time. The security personnel can report a plurality of incidents during the patrolling operation through the user interface of the security patrol management application. The centralized server (104) runs the server side security patrol management application in communication with the security patrol management applications running on the electronic communication devices (102) to monitor and manage the activities of the security personnel in real-time. The centralized server (104) receives the information related to the plurality of incidents and a plurality of evidences collected by the security personnel in form a video and image using the security patrol management application. The centralized server (104) running the server side security patrol management application can provide a plurality of alerts and additional jobs to the security personnel through the user interface of the security patrol management application. The server side security patrol management application is also used to provide a plurality of notification to the security personnel through the security patrol management application running on the electronic communication devices (102). The security personnel can set a job completion status through the user interface of the security patrol management application and the security personnel is then allowed to complete the patrolling operation by logging out of the security patrol management application. The server side security patrol management application running on the centralized server (104) receives real-time information from the security personal using the electronic communication device (102). The present system (100) and method allows administrators and managers of the security personnel management companies to monitor, analyze and manage the operations of the security personnel in real-time through the security patrol management application. Moreover the administrators and managers of the security personnel management companies can obtain real-time ground reports and this allows efficient management of the security personnel and the incidents that may happen during the patrolling operation.

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

What is claimed is:

1. A comprehensive system for real-time monitoring and management of a plurality of patrolling operations by a plurality of security personnel, comprising:
at least one electronic communication device configured to run a security patrol management application;
a centralized server running a server side security patrol management application capable of directly communicating with the security patrol management application running on the plurality of electronic communication devices;
wherein the server side security patrol management application is a cloud based application to collect a plurality of information to monitor and manage the patrolling operations of the security personnel in real-time, wherein the plurality of information includes:
a real-time location information of the security personnel;
a plurality of information from a plurality of patrol checkpoints;
a plurality of other data including alerts, text, audio and video information from the electronic communication devices; and
a plurality of other information including performance parameters of the security personnel;
a communication channel to enable communication between the plurality of electronic communication devices and the centralized server; and
a wireless communication device provided at the plurality of checkpoints to communicate with the electronic communication devices of the security personnel;
wherein the security patrol management application running on the electronic communication devices allows the plurality of security personnel to receive a plurality of data and instructions from the centralized server and enables automated transmission of the plurality of information to the centralized server for real-time monitoring and management of the plurality of operations of the security personnel.

2. The comprehensive system of claim 1, wherein the security patrol management application includes:
a contact management module for managing a plurality contact information of the plurality of security personnel and a plurality of security service providers;
a mapping module to define a plurality of structures, a plurality of objects and the plurality of checkpoints in a patrolling area;
an incident module to define and report a plurality of incidents during patrolling operation of the security personnel;
a job order module to define and assign a plurality of jobs to the security personnel during patrolling operation;
a scheduling module to schedule and route the plurality of security personal for patrolling operation;
a device management module to automatically configure the electronic communication devices of the security personnel;
an emergency contact module to set at least one emergency contact for contact in the event of an emergency;
a user access management module to configure at least one access level of each of the user including the plurality of security personnel;
an attendance module to capture a plurality of attendance and job timings of the security personnel;
a monitoring module to capture a plurality of real-time information including real-time location information of the security personnel, information from the plurality of patrol checkpoints including real-time scanning information, other data including alerts, text, audio and video information from the electronic communication devices; and
a report generating module to generate a plurality of reports including a plurality of patrolling operation related reports of each of the security personnel.

3. The comprehensive system of claim 1, wherein the electronic communication devices includes a smartphone, table, smart wearable device and any other smart device capable of launching the security patrol management application for communicating with the centralized server.

4. The comprehensive system of claim 1, wherein the security patrol management application includes a mobile application, web application and cloud application accessible from the electronic communication devices.

5. The comprehensive system of claim 1, wherein the centralized server is a cloud based server running the server side security patrol management application capable of being accessed from the plurality of electronic devices through at least one web browser and at least one web application.

6. The comprehensive system of claim 1, wherein the communication channel to enable communication between the electronic communication devices and the centralized server includes a wireless communication channel including Wi-Fi, mobile data, and other wireless data transfer means.

7. The comprehensive system of claim 1, wherein the server side security patrol management application is used to provide a plurality of notification to the security personnel through the security patrol management application running on the electronic communication devices.

8. The comprehensive system of claim 2, wherein the contact management module includes a security service provider contact management module and a security personnel contact management module.

9. The comprehensive system of claim 2, wherein the mapping module includes a patrol area and structure mapping module to map and visually present the structures and objects including buildings, floors and zones in the patrolling area.

10. The comprehensive system of claim 2, wherein the mapping module provides an interactive map of the plurality of structures, objects and the checkpoints in the patrolling area.

11. The comprehensive system of claim 2, wherein the mapping module further includes a checkpoint module to setup and visually present the checkpoints and a plurality of patrolling rules through the interactive map.

12. The comprehensive system of claim 1, wherein the wireless communication device includes a Bluetooth beacon functioning in form of the checkpoint for the security personnel during patrolling, wherein the electronic communication device of the security personnel is configured to communicate with the Bluetooth beacon to enable real-time monitoring of the patrolling operation by the server side security patrol management application running on the centralized server.

13. A method for real-time monitoring and management of a plurality of patrolling operations by a plurality of security personnel, comprising the steps of:
providing an electronic communication device configured to run a security patrol management application;
allowing the plurality of security personnel to register into the security patrol management application;
wherein the plurality of security personnel are provided with at least one unique user credentials for logging into the security patrol management application;
providing a plurality of patrol schedules for the plurality of security personnel through a user interface of the security patrol management application;
allowing the security personnel to select at least one patrol route involving a plurality of checkpoints for performing the patrolling operation;
checking into the plurality of checkpoints by enabling interaction with the electronic communication device and a wireless communication device;
wherein the wireless communication device includes a Bluetooth beacon assigned with a unique ID by the security patrol management application;
allowing the security personnel to report a plurality of incidents through the user interface of the security patrol management application;
providing a plurality of alerts and additional jobs to the security personnel through the user interface of the security patrol management application;
setting at least one job completion status through the user interface of the security patrol management application; and
allowing the security personnel to complete the patrolling operation by logging out of the security patrol management application.

14. The method of claim 13, wherein the security personnel are allowed to check-in to the plurality of checkpoints using the electronic communication device.

15. The method of claim 13, wherein the electronic communication device is provided with a wireless chip including an NFC chip to allow the security personnel to check-in the plurality of checkpoints.

16. The method of claim 13, wherein a centralized server running a server side security patrol management application in communication with the security patrol management applications running on the electronic communication devices monitors and manages a plurality of activities of the security personnel in real-time.

17. The method of claim 16, wherein the centralized server receives information related to the plurality of incidents and a plurality of evidences collected by the security personnel in form a video and image using the security patrol management application.
